(19) United States
(12) Patent Application Publication
(10) Pub. No.: US 2007/0287193 A1
(43) Pub. Date: Dec. 13, 2007

(54) Vial Assembly, Sampling Apparatus And Method For Processing Liquid-Based Specimens

(75) Inventors: Norman J. Pressman, Glencoe, IL (US); William J. Mayer, South Barrington, IL (US)

Correspondence Address: FOLEY AND LARDNER LLP;SUITE 500, 3000 K STREET NW, WASHINGTON, DC, 20007, US

(73) Assignee: MONOGEN, INC., Vernon Hills, IL (US)

(21) Appl. No.: 11/667,296

(22) PCT Filed: Nov. 9, 2004
(86) PCT No.: PCT/US04/37249

§ 371 Date: May 8, 2007

(51) Int. Cl. G01N 1/18; B01L 11/00; B01L 3/00; G01N 1/00

(52) U.S. Cl. 436/178; 422/101; 422/102; 422/58; 436/174; 436/177

(57) ABSTRACT

A vial-based system and method for handling and processing specimens of particulate matter-containing liquid directly in the vial. A processing assembly (40), which includes a stirrer (45) and a particulate matter separation chamber (46), is releasably coupled to the inside of a vial cover (30). The processing assembly (40) remains with the cover (30) when the vial is opened to insert a specimen therein. Application of an external force to the cover (30) detaches the processing assembly from the cover so that it remains in the vial, for access by automated or manual laboratory equipment, when the cover (30) is discarded. Sealing and drainage features help prevent cross-contamination during specimen processing.

### CROSS-REFERENCE TO RELATED APPLICATIONS

This application is a continuation-in-part of U.S. application Ser. No. 10/122,151, filed Apr. 15, 2002 (US 2003/0077838 A1); and is a continuation-in-part of U.S. application Ser. Nos. 10/274,366 (US 2003/0092186 A1) and 10/274,380 (US 2003/0092170 A1), both filed Oct. 21, 2002. These three applications are incorporated herein by reference.

### TECHNICAL FIELD

The present invention is directed to an apparatus and a method for collecting and processing fluid specimens, including collecting uniform layers of particulate matter from specimens for subsequent testing or analysis, e.g., cells from a biological fluid specimen, such as in cytology protocols, or non-biological particulates in solution, such as impurities in drinking water.

### BACKGROUND

In a wide variety of technologies, the ability and/or facility in separating matter, typically particulate matter, from a fluid is a critical component in the ability to test for the presence of substances in the fluid. Too often, interference associated with sample preparation obscures the target particles to such a degree that the process is not sufficiently reliable or is too costly, or the particulate analysis is not quantifiable. Such problems exist in various fields of examination which involve detection and/or diagnosis, including environmental testing, radiation research, cancer screening through cytological examination, microbiological testing, and hazardous waste contamination, to name just a few.

Cytological examination of a sample begins with obtaining specimens including a sample of cells from the patient, which can typically be done by scraping, swabbing, or brushing an area, as in the case of cervical samples, or by collecting body fluids, such as those obtained from the chest cavity, bladder, or spinal column, or by fine needle aspiration or fine needle biopsy. In a conventional manual cytological preparation, the cells in the fluid are then transferred directly or by centrifugation-based processing steps onto a glass slide for viewing. In a conventional automated cytological preparation, a filter assembly is placed in the liquid suspension and the filter assembly disperses the cells, eliminates (i.e., passes through) small particulate matter (e.g., debris and erythrocytes of limited or no diagnostic significance), and captures the cells on the filter. The filter is then removed and placed in contact with a microscope slide.

In all of these endeavors, a limiting factor in the sample preparation protocol is adequately separating solid matter from its fluid carrier, and in easily and efficiently collecting and concentrating the solid matter in a form readily accessible to examination, by human experts or image analysis machines, under a microscope. Diagnostic microbiology and/or cytology, particularly in the area of clinical pathology, bases diagnoses on a microscopic examination of cells and other microscopic analyses. The accuracy of the diagnosis and the preparation of optimally interpretable specimens typically depends upon adequate sample preparation. In this regard the ideal specimen would consist of a monolayer of substantially evenly spaced cells of diagnostic significance. Newer methodologies such as immunocytochemistry, in situ hybridization, and image analysis require preparations that are reproducible, fast, biohazard-free and inexpensive.

Currently, biological samples are collected for cytological examinations using special containers. These containers usually contain a transport solution for preserving the cytology specimen during shipment from the collection site to the diagnostic cytology laboratory. Further, cytology specimens collected from the body cavities using a swab, smear, spatula or brush are also preserved in special containers with fixatives (e.g., alcohol or acetone fixatives) prior to transferring cells onto the slide or membrane for staining or examination.

Specimen containers are known that allow a liquid-based biological specimen to be processed directly in the container so as to obtain a substantially uniform layer of cells on a collection site (in a filter housing defining a particulate matter separation chamber) that is associated with the container itself. See, for example, U.S. Pat. Nos. 5,301,685; 5,471,994; 6,296,764; and 6,309,362, all of which are incorporated herein by reference. However, these types of specimen containers require specially configured apertured covers and adapters therefor that are designed to mate with the filter housing, and with suction equipment (e.g., a syringe or a mechanized vacuum source) used to aspirate liquid from the container and draw it through the filter. Further, extraction of the filter so that it can be pressed against a microscope slide to transfer collected cells to the slide requires disassembly of the cooperating parts of the cover and/or adapters associated therewith. If the processing is done by automated equipment, special handling devices are required to carry out such disassembly. All of this complexity adds time and material and labor cost to the processing required prior to the actual cytology examination.

Parent applications US 2003/0077838 A1, US 2003/0092186 A1, and US 2003/0092170 A1 disclose a specimen vial system that houses a complete processing assembly (mixer with separation chamber and aspiration tube). They also disclose a filter assembly adapted for use in the separation chamber. The processing assembly normally is prepackaged with a liquid preservative solution. The processing assembly is used for stirring the liquid-based specimen in the vial and for holding a filter on which a uniform layer of cells can be collected from the specimen. The stirring function serves to liquefy non-cellular components within the vial, such as mucous, and to create a homogeneous distribution of cellular material. The processing assembly is coupled to a cover for the vial by means of a releasable coupling. When the cover is removed at the point-of-care site (doctor's office, clinic, hospital, etc.), the processing assembly remains with the cover to allow medical personnel access to the container interior for insertion of a biological specimen into the vial. The cover, along with the attached processing assembly, is then replaced to seal the vial, and the vial may then be sent to a laboratory for processing. The releasable coupling keeps the processing assembly spaced above the bottom of the container, and allows the processing assembly to separate from the cover, which is still tightly secured to the container, by downward movement relative to the cover, e.g., by pressing downwardly on the center of the cover. When separation occurs, the processing assembly drops, remaining in the vial for access by automated or manual laboratory equipment when the cover is subsequently removed.

### SUMMARY DISCLOSURE OF THE INVENTION

The invention concerns various enhancements to the specimen vial system and filter assembly disclosed in parent applications US 2003/0077838 A1, US 2003/0092186 A1, and US 2003/0092170 A1. Metering of the specimen as it is withdrawn from the vial, as well as introducing a small amount of air into the specimen near the top of the aspiration tube, helps to improve the quality of the slide-mounted samples. Improved sealing and drainage in critical areas, and features designed to prevent premature detachment of the processing assembly from the cover, help to prevent cross-contamination during specimen processing. A tamper and seal integrity indicator is also included.

A first aspect of the invention concerns features that affect the outflow of fluid samples from the bottom of the specimen vial. A vial for holding and processing a fluid specimen comprises a container and a processing assembly disposed in the container. The container has a surrounding wall with an opening at its upper end and a bottom wall closing the bottom end. The processing assembly is adapted to be engaged through the opening by an external device adapted to remove fluid from the container, and has a depending tube with an open bottom end adapted to contact the bottom wall. The bottom end of the tube and the bottom wall of the container are configured to form a plurality of discrete contact areas at their interface and a plurality of discrete fluid inlets to the tube between the contact areas.

In various embodiments the bottom end of the tube and/or the bottom wall of the container may have a plurality of standoffs that, together with the bottom wall and the bottom end of the tube, form the inlets. In some embodiments the bottom end of the tube may have standoffs in the form of peripherally spaced feet that contact the bottom wall of the container to define a plurality of peripherally spaced inlets to the tube. In other embodiments the bottom wall of the container may have standoffs in the form of ribs, e.g., disposed radially, against which the bottom end of the tube rests to define the inlets.

The objective is to draw specimen fluid from the lowest part of the container, where particulates may settle even after vigorous mixing, while metering to prevent the passage of particulates larger than a specified threshold. Accordingly, this aspect of the invention may be characterized alternatively as involving a processing assembly that has a plurality of peripheral inlets at or immediately adjacent the bottom end of the tube, the processing assembly being supported by the container with the bottom end of the tube in contact with or immediately adjacent the bottom wall.

According to a second aspect of the invention, a vial for holding and processing a fluid specimen comprises a container and a processing assembly disposed in the container. The container has a surrounding wall with an opening at its upper end and a bottom wall closing the bottom end. The processing assembly is adapted to be engaged through the opening by an external device adapted to remove fluid from the container, and has a depending tube with at least one inlet for fluid at its bottom end. The upper portion of the tube has a vent hole in communication with the lumen of the tube above the level of fluid in the vial.

A third aspect of the invention involves a method for obtaining a particulate matter sample from a specimen of particulate matter-containing fluid in a container. This involves withdrawing particulate matter-containing fluid from the container through a conduit that communicates with a separation chamber; introducing a gas into the fluid as it flows from the container, the gas mixing with the fluid to disperse the particulate matter therein; and separating out particulate matter from the fluid in the separation chamber.

This method may be used, for example, to collect cells for cytology from a biological specimen fluid in a container. The introduced gas mixes with the specimen fluid to disperse the cells and other biological matter therein, after which the cells are separated from the specimen fluid in the separation chamber.

Another aspect of the invention concerns a releasable coupling between the processing assembly and a cover for the vial. A vial for holding and processing a fluid specimen comprises a container having a surrounding wall defining an opening at its upper end, a cover-engaging portion near the opening, and a bottom wall closing the bottom end of the surrounding wall; a removable cover having a container-engaging portion that mates with the cover-engaging portion of the surrounding wall so that the cover can close and seal the opening; and a processing assembly releasably coupled to the cover so as to be removable from the container with the cover while still coupled to the cover. The processing assembly has a bottom end that contacts the bottom wall of the container when the cover is fully engaged with the container to close and seal the opening. Further, the processing assembly is selectively detachable from the cover when the cover is elevated relative to the container so that the processing assembly can remain in the container when the cover is subsequently removed from the container.

Yet another aspect of the invention concerns how a vial with a releasable processing assembly is used. The vial comprises a container having a surrounding wall defining an opening at its upper end and a bottom wall closing the bottom end of the surrounding wall; a cover removably engageable with the surrounding wall to close the opening; and a processing assembly releasably coupled to the inside of the cover. The method for processing a fluid specimen in a vial comprises at least partially disengaging the cover from the container to elevate the cover and the attached processing assembly; detaching the processing assembly from the cover to deposit the processing assembly in the container; completely removing the cover from the container to expose the detached processing assembly in the container; and manipulating the processing assembly so as to process the specimen in the container.

In the case of a vial with a processing assembly that is wedged between the cover and the bottom wall of the container when the cover is fully engaged with the container, the method is as recited above, and the step of at least partially disengaging the cover from the container is intended to provide sufficient clearance between the processing assembly and the bottom wall of the container to allow the processing assembly to be detached from the cover.

A further aspect of the invention concerns vial sealing features. A vial for holding and processing a fluid specimen comprises a container having a surrounding wall defining an opening at its upper end, a cover-engaging portion near the opening, and a bottom wall closing the bottom end of the surrounding wall; a removable cover having a container-engaging portion that mates with the cover-engaging portion of the surrounding wall so that the cover closes and seals the opening; and a processing assembly in the container comprising an upper portion disposed near the opening, the upper portion comprising a base with a hole, and an annular projection surrounding the hole and extending upwardly from the base to define a cup-shaped recess. The cover has an annular sealing member that mates and seals with the annular projection on the processing assembly when the cover closes and seals the opening. The cover also has a depending hole sealing member that seals the hole in the base when the cover closes and seals the opening.

Preferably, the annular sealing member has an annular projection that seals against the inside of the surrounding wall of the container. The processing assembly preferably is releasable from the cover, and preferably includes a depending tube that contacts the bottom wall of the container when the cover is fully engaged with the container to close and seal the opening, so that the processing assembly is wedged in place.

Yet another aspect of the invention concerns a filter assembly adapted for use in apparatus for separating and collecting a layer of particulate matter from a fluid containing the particulate matter. The apparatus has a particulate matter separation chamber into which the filter is placed, the separation chamber defined by a bottom wall with a fluid inlet and an annular wall projecting upwardly from the bottom wall. The filter assembly comprises a holder and a filter in the holder having a collection site adapted to collect a layer of the particulate matter. The holder is configured to contact and effect an annular seal with the annular wall of the separation chamber when the filter assembly is positioned in the separation chamber with the filter facing the bottom wall.

Preferably, the upper margin of the holder is flared outwardly to define a flange that seals against the annular wall of the separation chamber. The upper margin of the inner face of the annular wall of the separation chamber preferably tapers inwardly, in which case the periphery of the flange is adapted to form a thin annular seal against the tapered surface of the annular wall of the separation chamber.

A final aspect of the invention concerns a vial tamper and seal integrity feature. A specimen vial comprises a container, a removable cover for the container and a frangible indicator element secured to the container and the periphery of the cover. The cover and the upper portion of the container have mating coupling elements that engage or disengage by relative rotation of the container and the cover, and mating sealing portions for effecting and maintaining an air-tight seal between the cover and the container from a fully engaged cover position through an unsealing arc that extends up to a partially engaged cover position at which the sealing portions no longer maintain a reliable seal. The indicator element is secured to the container and the periphery of the cover when the cover is in the fully engaged position. The indicator element has an index mark on at least its cover portion, and the container portion of the indicator element has a boundary mark spaced from the index mark when the indicator element is unbroken by a distance no greater than the length of the unsealing arc. Accordingly, removal or loosening of the cover will break the indicator element, and a partially disengaged cover condition with the cover-borne index mark beyond the boundary mark will indicate an unreliably sealed condition of the vial.

### BRIEF DESCRIPTION OF THE DRAWING FIGURES

A preferred embodiment that incorporates the best mode for carrying out the invention is described in detail below, purely by way of example, with reference to the accompanying drawing, in which:

FIG. 1 is a vertical sectional view through a specimen vial according to the invention (with cross-hatching omitted for the sake of clarity), showing the processing assembly in the vial coupled to the cover, which is fully screwed onto the container portion of the vial, and a quantity of fluid;

FIG. 2 is a perspective view of the container portion of the vial;

FIG. 3 is a top plan view of the container, shown with the processing assembly removed;

FIG. 4 is a perspective view of the processing assembly;

FIG. 5 is a top plan view of the processing assembly;

FIG. 6 is a bottom plan view of the processing assembly;

FIG. 7 is an exploded vertical sectional view of the processing assembly and a filter assembly adapted for use in the processing assembly;

FIG. 8 is a top plan view of the center portion of the bottom wall of the container according to another embodiment of the invention;

FIG. 9 is an elevational view of the lower portion of the processing assembly according to another embodiment of the invention;

FIG. 10 is a vertical sectional view of the upper portion of the processing assembly taken along line 10-10 in FIG. 5, showing the filter assembly in place in the particulate matter separation chamber and engaged by a suction head;

FIG. 11 is a partial schematic view of the arrangement depicted in FIG. 10, showing the flow of liquid and particulate matter separated therefrom;

FIG. 12 is a vertical sectional view of the lower portion of the processing assembly taken along line 12-12 in FIG. 6;

FIG. 13 is a vertical sectional view of the specimen vial similar to FIG. 1 (with cross-hatching omitted for the sake of clarity), but showing the cover partially unscrewed and the processing assembly detached from the cover;

FIG. 14 is a perspective view of a closed and labeled vial assembly;

FIG. 15 is a schematic view of the seal integrity indicator of the vial assembly; and

FIG. 16 is a top plan view of an automated apparatus for handling vials according to the invention and carrying out various specimen processing steps.

It is to be understood that the invention is not limited in its application to the details of construction and the arrangement of components of the preferred embodiment described below and illustrated in the drawing figures. Various modifications will be apparent to those skilled in the art without departing from the scope of the invention, which is defined by the appended claims. Further, while the preferred embodiment is disclosed as primarily useful in the collection and processing biological fluids for cytology examination, it will be appreciated that the invention has application in any field in which samples of particulate matter are to be prepared from a liquid that contains such particulate matter, such as drinking water with insoluble impurities.

### DETAILED DESCRIPTION

Vial Configuration

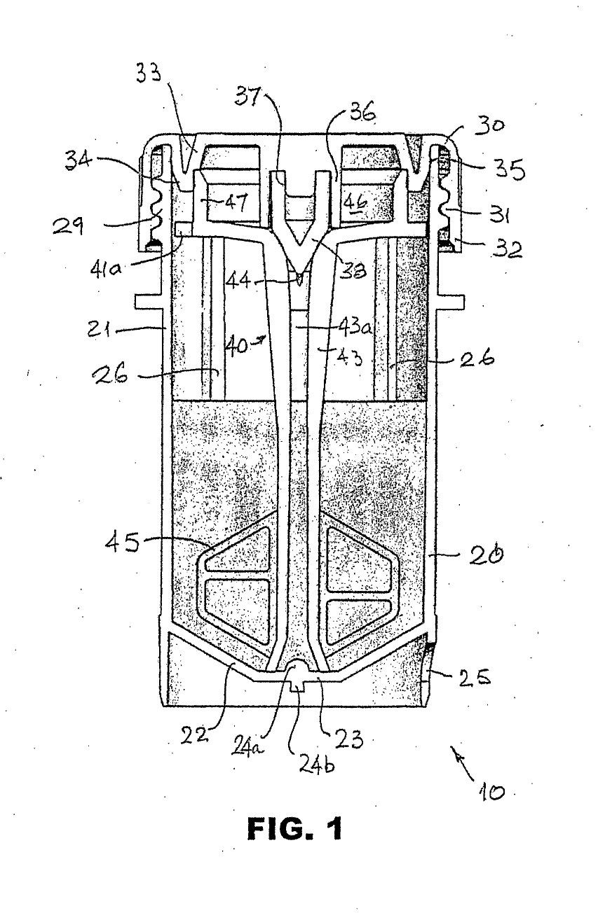

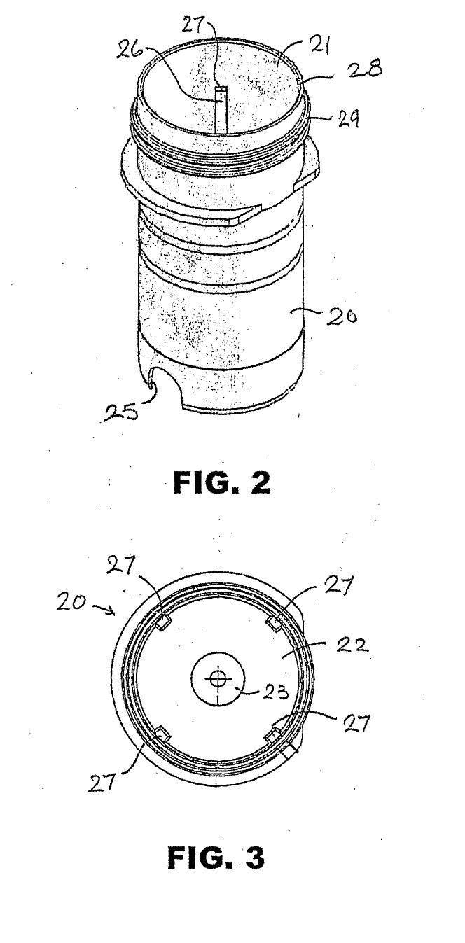

Referring to FIGS. 1, 2, 3 and 14, a vial 10 according to the invention comprises a container 20, a cover 30 and a rotatable processing assembly 40. Processing assembly 40 is designed to carry out several functions, among them mixing (note the presence of mixing vanes 45), and for this preferred rotary embodiment will be referred to as a stirrer for the sake of convenience.

Container 20 preferably is molded of plastic, preferably polypropylene, and has a substantially cylindrical wall 21, surrounding its longitudinal axis, joined to a frustoconical bottom wall 22. The central portion 23 of bottom wall 21 is flat except for the very center, which has vestigial protrusions 24a, 24b resulting from the injection molding process. The outer surface of wall 21 receives an adhesive label having a bar code and other indicia. The bar code can be used, e.g., to link the specimen placed in the vial to patient identifying data and instructional processing information.

The bottom end of wall 21 has an arcuate notch 25, which acts to keep the container in a proper orientation when handled, e.g., by automated laboratory processing equipment designed to cradle the container and move it through various processing stations. At least three, but preferably four longitudinal ribs 26 project inwardly from wall 21. The upper ends 27 of ribs 26 cooperate with the processing assembly 40 during fluid aspiration, as described below. The top of container 20 has an opening 28 and a standard right-hand helical thread 29 that preferably extends for two turns and mates with a similar thread on cover 30. Other types of rotatable cover-to-container coupling may be used, such as a bayonet coupling.

Cover 30 is molded of plastic (preferably polyethylene) with internal threads 31 on its externally knurled outer flange 32. Cover 30 also has an annular coupler 33 that is spaced from flange 32 and preferably is externally tapered at its distal end 34 to facilitate insertion into container 20. However, the outer proximal portion 35 of coupler 33 is dimensioned such that it forms a tight plug seal with the inner surface of container wall 21 through at least one revolution of cover 30 relative to container 20 away from the fully tightened position. Cover 30 also has a central annular boss 36 that projects further from the top of cover 30 than annular coupler 33 so as to interact with processing assembly 40, as described below. Annular boss 36 has a central recess 37 that retains a tapered stopper 38, preferably made of polyethylene, which also interacts with processing assembly 40.

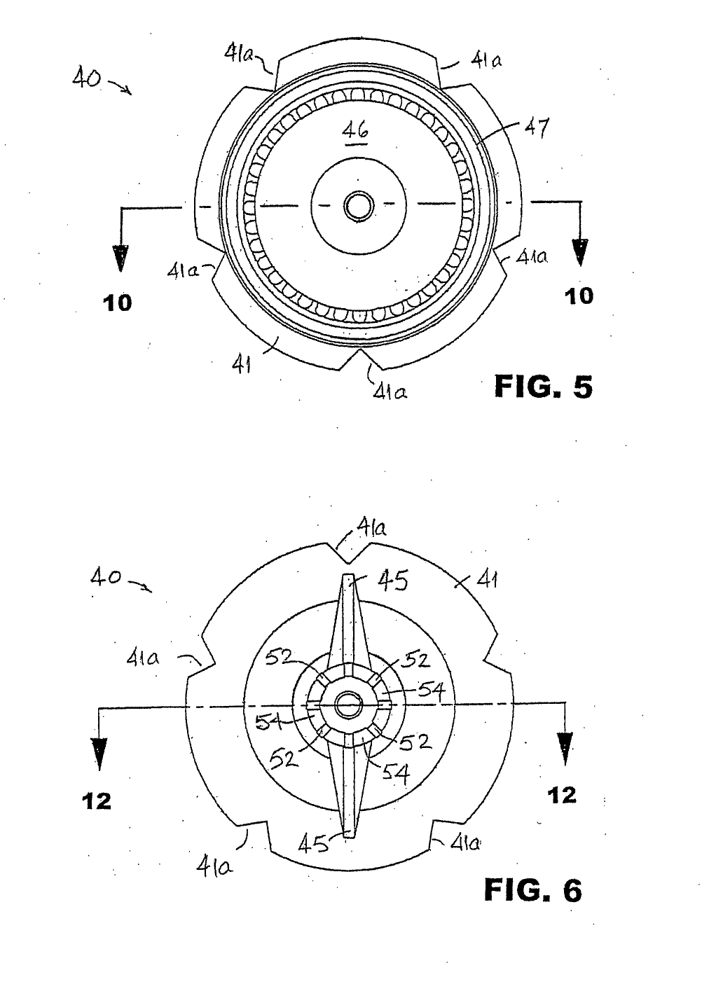

Referring to FIGS. 1 and 4-7, processing assembly 40 is in the form of a stirrer molded of plastic, preferably polypropylene, having a circular base or bottom wall 41, sloped at its center, with a central inlet port 42; a central depending suction tube 43 with at least two inlets at or adjacent the bottom end; and a dispersing (mixing) element in the form of laterally extending vanes 45. The upper portion of the stirrer 40 has a cup-shaped particulate matter separation chamber or manifold 46 defined by base 41 and an upstanding annular wall 47. The upper edges of wall 47 are beveled, the inner edge 48 preferably being beveled to a greater degree to facilitate placement of a filter assembly F in manifold 46, as described below.

Annular wall 47 serves as a coupler for releasably coupling the stirrer 40 to cover 30, and is therefore dimensioned to fit snugly within annular coupler 33 (see FIG. 1). Specifically, there is a friction or press fit between couplers 33 and 47 such that normal handling of cover 30 when removed from container 20 (e.g., to place a biological specimen in the container) will not cause separation of the stirrer from the cover. Coupler 47 is dimensioned relative to coupler 33 so that there is a very slight initial diametrical interference, preferably about 0.31 mm. Coupler 47 is stiffer than coupler 33, so assembly of the stirrer to the cover involves slight deformation principally of coupler 33, resulting in a frictional force that keeps the stirrer and the cover engaged.

Stirrer 40 is dimensioned such that the bottom end of the suction tube 43 contacts the bottom wall 23 of container 20 when the cover 30 is screwed tightly onto container 20. In other words, stirrer 40 is wedged between cover 30 and the bottom of container 20 when the vial is fully closed. This arrangement prevents stirrer 40 from inadvertently becoming detached from cover 30 when the vial is closed. It also ensures reattachment of the stirrer to the cover in the event the stirrer becomes separated from the cover when they are removed from the container 20, such as at a point-of-care site where a specimen is collected. The physician, clinician or other healthcare provider, wearing protective gloves, simply can place the dislodged stirrer back into the container and screw on the cover 30. Tightening of the cover will force couplers 33 and 47 to reengage as the stirrer is squeezed between the cover and the bottom of the container.

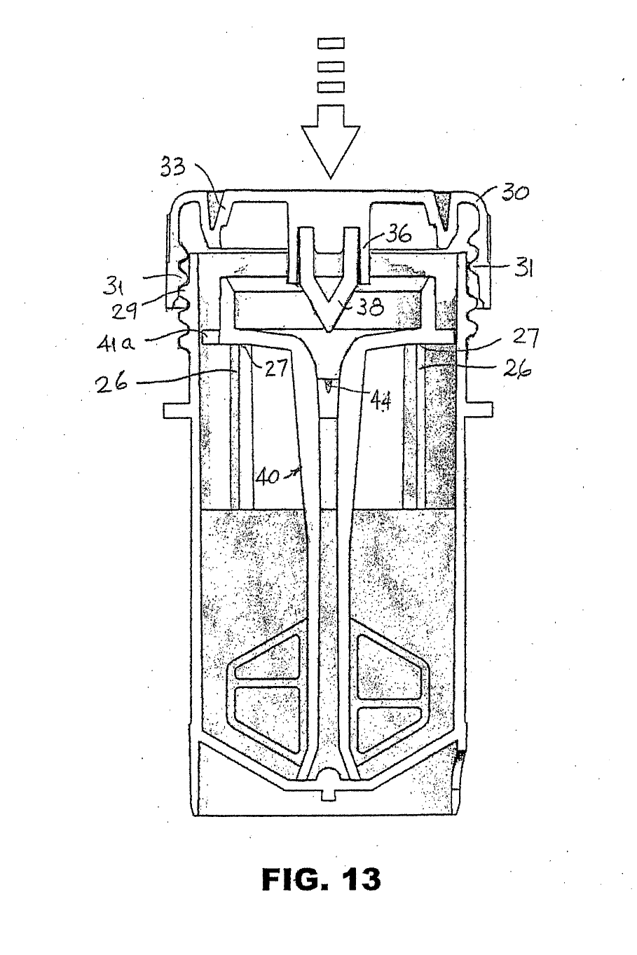

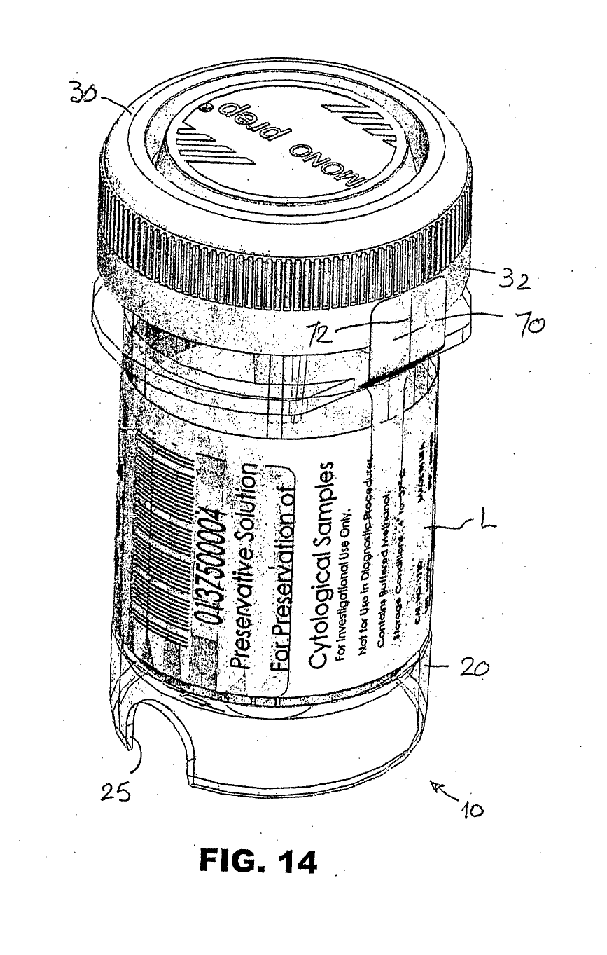

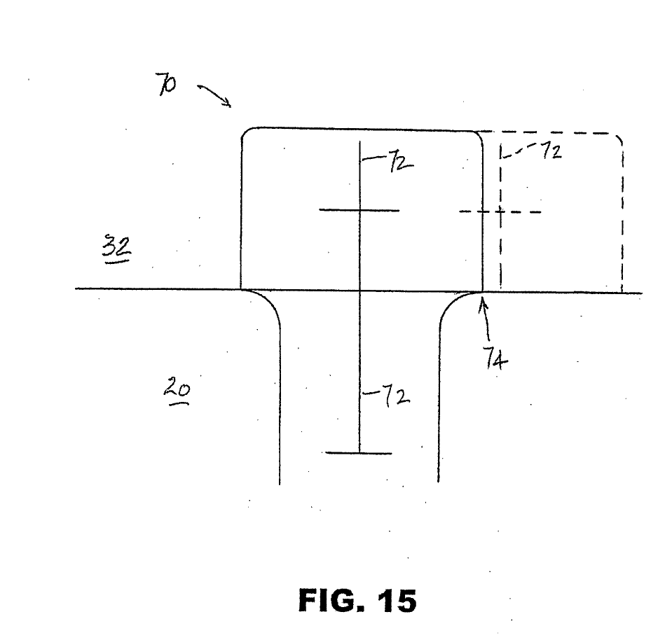

Separation of stirrer 40 from cover 30 is intended to occur when the specimen in vial 10 is ready for processing, such as in the automated specimen processor of FIG. 15 (described below). With the vial stably supported on a suitable platform—preferably with a key or protrusion that mates with notch 25 in the container wall—cover 30 is unscrewed slightly more than two full turns (preferably 2¼ turns) so that coupler 33 no longer seals against the container wall 21 and threads 29 and 31 can no longer retain cover 30 on container 20. See FIG. 13. However, in this position thread 31 of cover 30 rests on the uppermost surface of thread 29 of container 20.

Cover 30 thus is supported on container 20 when an external downward force (see the arrow in FIG. 13) is applied to the center of cover 30. This deflects the center part of cover 30 inwardly. As illustrated in FIG. 1, central boss 36 is dimensioned such that its distal end just contacts or lies very close to base 41 of the stirrer 40. Thus, when the central portion of the cover is depressed, central boss 36 will deflect further than annular coupler 33 and push stirrer 40 out of engagement with coupler 35. Inward deflection of the central portion of cover 30 also causes coupler 35 to spread outwardly, thereby lessening the retention force and facilitating detachment of the stirrer. The separation force applied to cover 30 required to detach the stirrer should be in the range of 7 to 30 lbs., preferably about 12 lbs.

Once detached from the cover 30, stirrer 40 comes to rest on the upper ends 27 of ribs 26. See FIG. 13. The particulate matter separation chamber (manifold) 46 thus is stably supported near the container opening and is easily accessed by processing equipment, whether manual or automatic, which will manipulate the stirrer so as to process the specimen directly in the container. At least three ribs 26 are required to form a stable support for the stirrer, but four are preferred because that number seems to promote more thorough dispersion of the particulate matter in the liquid during stirring.

Sealing and Drainage

Several features ensure proper sealing of the vial and minimize the possibility of cross-contamination. When cover 30 is fully screwed onto container 20, a triple fluid-tight seal is formed: (a) between annular coupler 33 and container wall 21; (b) between coupler 33 and annular wall 47 of stirrer 40; and (c) between stopper 38 and the upper end of tube 43. The latter two seals isolate manifold 46, keeping it dry. Manifold 46 remains sealed and dry even when cover 30 is removed with stirrer 40 attached for the purpose of inserting specimen material in the vial. If the stirrer should become dislodged when the cover is removed, replacement of the stirrer in the container and tightening of the cover will force couplers 33 and 47 to reengage and reseal the manifold 46 as the stirrer is squeezed between the cover and the bottom of the container.

Before the cover is unscrewed with stirrer 40 attached, any fluid residing in the annular area above bottom wall 41 and outside wall 47 drains back into the container via notches 41a at the periphery of bottom wall 41. This keeps the upper region of the container free of excess specimen fluid. Five peripheral notches 41a are illustrated as preferred, but a smaller or greater number of notches may be used. Notches 41a also allow for fluid drainage from this annular area back into the container during specimen processing in the laboratory.

Because of the length of annular coupler 33 and the lowered position of threads 29, the outermost seal at 35 is maintained even as cover 30 is unscrewed for up to about one revolution. When fully unscrewed, as in the position shown in FIG. 13, the outermost seal at 35 is broken. Accordingly, when a force is applied to cover 30 to detach stirrer 40 from the cover, the deflection of the central portion of the cover will not pressurize the container and cause a “pumping action” that would otherwise force fluid up through tube 43 and into manifold 46.

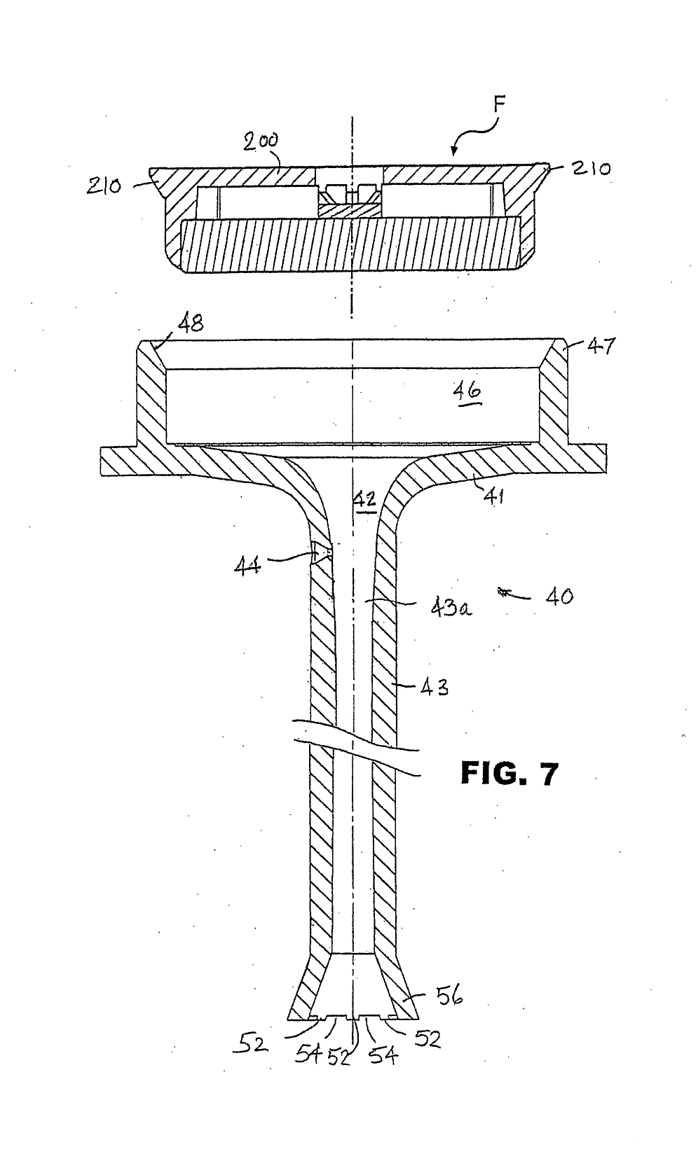

Referring to FIGS. 1 and 7, a vent hole 44 near the upper end of aspiration tube 43 communicates with the lumen 43a of the tube. When aspiration of fluid during specimen processing is complete, vent hole 44 serves to break the vacuum that would otherwise be present in manifold 46 and tube 43 while the aspiration head (see FIG. 10) is still sealed to the manifold. This allows excess fluid in manifold 46 and in the portion of tube 43 above the fluid level in the container to drain quickly into the container, preventing excessive fluid draw. This allows the collected sample on the surface of the filter membrane 205 to stabilize more quickly. It also helps to avoid unsatisfactory slide-mounted samples of excessive cellularity.

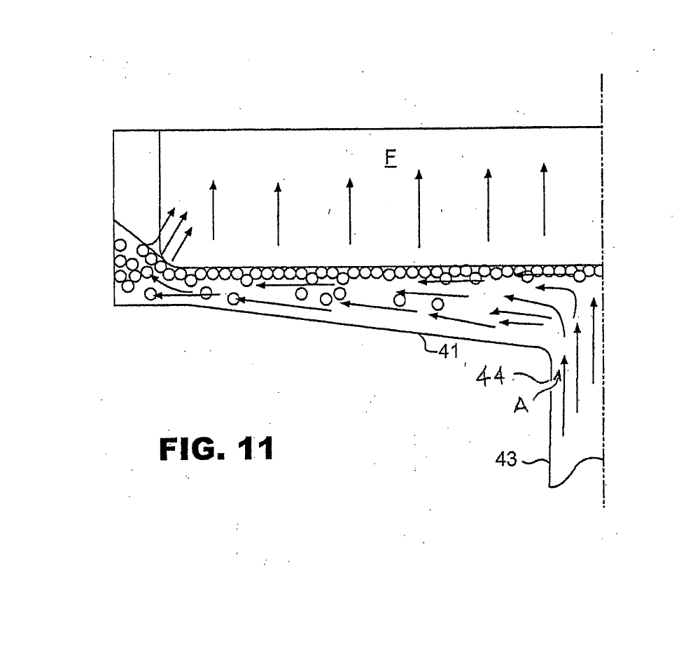

Vent hole 44 affords an added benefit. During aspiration of fluid through tube 43, a small quantity of air is drawn into the tube through vent hole 44. This air (A in FIG. 11) mixes with the specimen fluid and aids in specimen disaggregation to yield more uniform distribution of particulates (e.g., cells) on the filter F and higher quality slide-mounted samples. The vent hole should be located as high as possible in the aspiration tube 43 to drain a maximum amount of fluid back into the container, but not so high as to adversely affect fluid dynamics during aspiration. The minimum flow area through the vent hole 44 should be in the range of about 0.5% to about 15% of the minimum flow area through the tube 43, and preferably should be about 1.6% of the flow area through the tube. A plurality of vent holes may be provided, as long as the combined flow area of all the vent holes fall within the above range.

Sample Metering

A small percentage of patient specimens, as may be found in gynecological Pap test and other specimen types, contain large clusters of cells, artifacts, and/or cellular or noncellular debris. Some of these large objects, if collected and deposited on a slide, can obscure the visualization of diagnostic cells and, consequently, result in a less accurate interpretation or diagnosis of the slide sample. Since most of these features are not of diagnostic relevance, their elimination from the sample is, in general, desirable. To achieve this result, close control of the bottom inlets to the suction tube 43 is maintained, as follows.

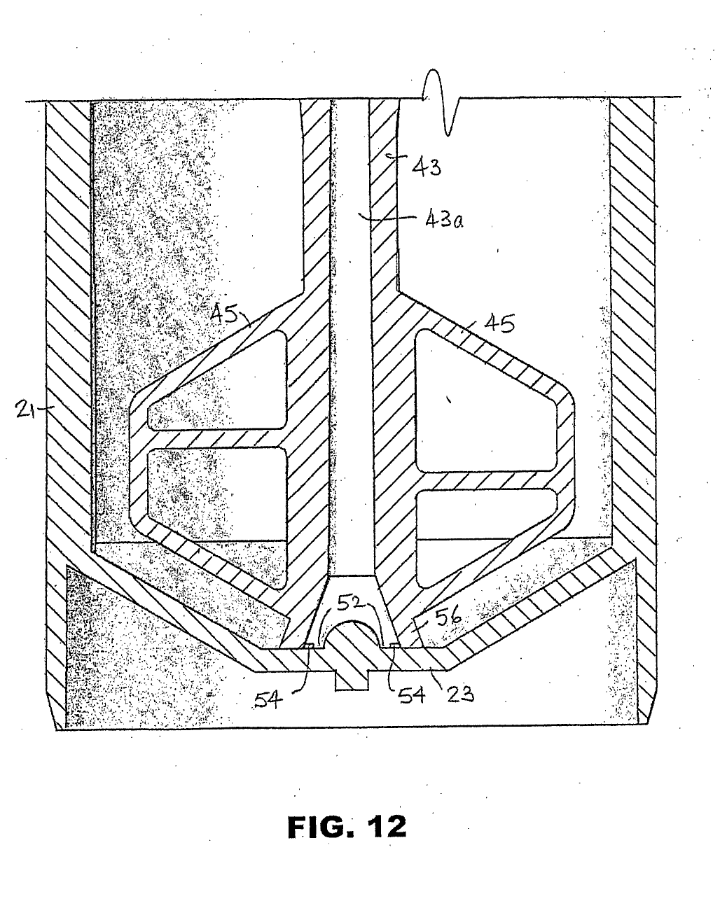

Referring to FIGS. 4, 6, 7 and 12, the bottom end of aspiration tube 43 is provided with a plurality of standoffs in the form of peripherally spaced feet 52 that contact the bottom wall 23 of the container to define a plurality of peripherally spaced inlets 54 to the tube. This interface effectively forms a plurality of metering valves. Proper sizing and spacing of the feet 52 (and therefore the inlets 54) prevents large objects from entering the suction tube 43, while allowing the passage of smaller objects that may be diagnostically useful. The minimum dimension of the cross-section of any inlet (as well as the minimum height of any foot) for cytology specimens preferably is in the range of about 0.004 in. to about 0.020 in. For gynecological specimens, the minimum height of any foot (or any inlet) preferably is about 0.010 in. For non-cytology specimens the preferred minimum inlet size will depend on the size distribution of the particulates in the specimen.

While the inlets 54 have a thin (low) passage section as illustrated and a small metering area, clogging is not an issue due to the relatively wide dimension. Having a plurality of inlets ensures that fluid flow will not be interrupted because, should one inlet become clogged, others will accommodate the flow. Further, because the bottom end of the tube is flared outwardly at 56, a net larger inlet area is formed to help the fluid bypass any clogged inlets. Eight feet (defining eight inlets) are shown in the figures, but a different number of feet may be used—two at a minimum. Although squared-off feet are shown, the feet could have rounded inside corners, and/or could have rounded outside corners. Regardless of the number or shape of the feet, minimum inlet size preferably should fall within the above cross-section range of about 0.004 in. to about 0.020 in for cytology specimens.

Substantial contact of the tube with the bottom wall 23 of the container is important. To that end, aspiration tube 43 is dimensioned such that it is slightly longer (by about 0.020 in.) than the distance between the tops 27 of ribs 26 and the bottom wall 23. Thus, when the aspiration head engages the stirrer with a downward force (see FIG. 10), the feet 52 will firmly contact bottom wall 23, which can flex downwardly if necessary depending on manufacturing tolerances.

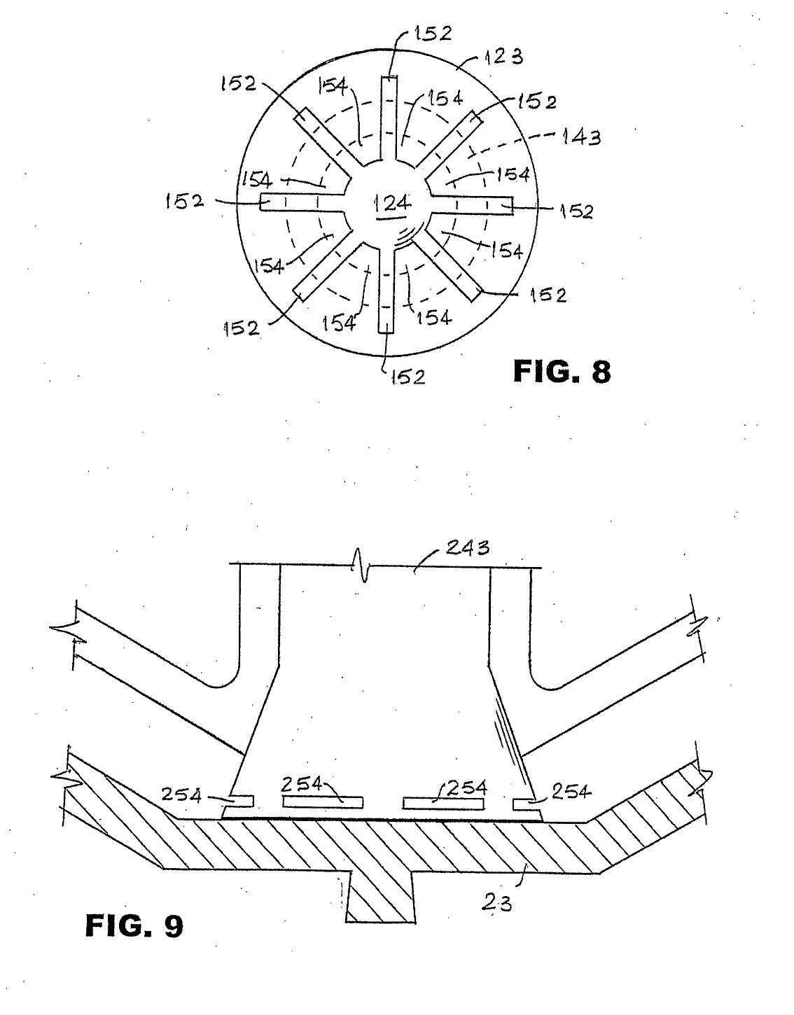

The objective is to draw specimen fluid from the lowest part of the container, where particulates may settle even after vigorous mixing, while metering to prevent the passage of particulates larger than a specified threshold. Other inlet-defining structural arrangements at the interface between the bottom end of suction tube 43 and bottom wall 23 may be used to accomplish this. For example, the bottom end of tube 43 may be smooth (i.e., have no feet), while the bottom wall 23 may have standoffs against which the end of tube 43 rests. FIG. 8 shows an example of this arrangement, in which bottom wall 123 is provided with integrally molded, upstanding, radial ribs 152. The annular bottom end face 143 of the suction tube is shown in dashed lines superposed above the ribs 152. Here, eight ribs 152 are shown radiating from a central boss 124, the ribs and the end of the suction tube defining eight inlets 154. Ribs or standoffs of different shape (e.g., curved), number and/or configuration could also be used as long as they cooperate with the bottom end of the suction tube to define a plurality of inlets of proper size.

Alternatively, standoffs could be provided on both the bottom end of the suction tube and the bottom of the container, the standoffs cooperating to define a plurality of inlets of the required size. However, inasmuch as such an arrangement could interfere with rotation of the processing assembly (stirrer) during mixing, it is better left to embodiments in which the processing assembly does not rotate, with mixing effected by some other instrumentality (see below).

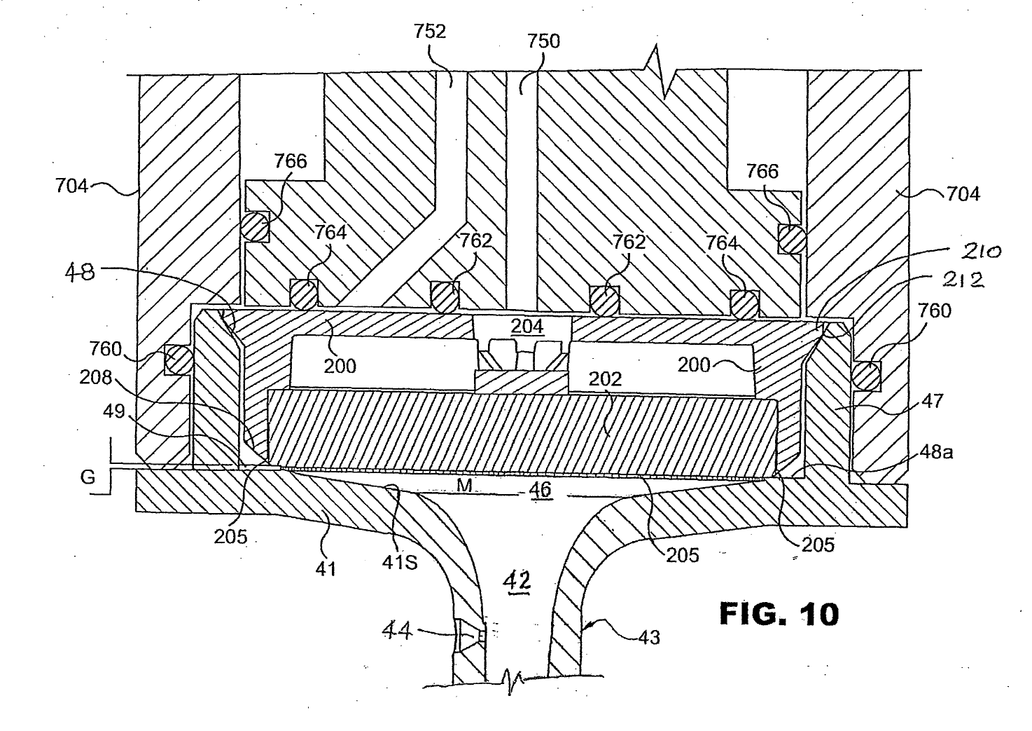

In lieu of structures that define inlets between the bottom end of the suction tube and bottom wall 23 of the container, the suction tube may have a plurality of peripherally spaced orifices located immediately adjacent the bottom end of the tube. FIG. 9 shows an example of these orifices as elongated openings 254 in suction tube 243; other shapes (not shown) may also be used. Regardless of the inlet arrangement, minimum inlet size preferably should fall within the above cross-section range of about 0.004 in. to about 0.020 in. for cytology specimens.

While a rotatable processing assembly 40 with mixing vanes 45 has been disclosed, it will be appreciated that specimen mixing could be accomplished without rotation of the processing assembly by using other known types of agitating arrangements. For example, vibratory energy could be applied to the upper portion of a processing assembly having mixing elements that are suitably designed to impart such energy efficiently to the specimen fluid. As another example, vibratory energy could be imparted to the container 20 when appropriately supported, and the processing assembly may be devoid of mixing elements or have mixing elements that enhance the vibrational mixing. As yet another example, ferromagnetic beads could be incorporated in the vial (e.g., at the factory), and these beads would be caused to move throughout the specimen under the influence of a moving magnetic field imposed, e.g., by a rotating magnet located beneath the vial. Such beads would remain in the vial during sampling because the metering feature of the invention, described above, would prevent the beads from becoming entrained in the fluid sample as it is removed from the container. In such an embodiment, the processing assembly could have no mixing elements, or small mixing elements that cooperate with the beads to enhance mixing. Regardless of the type of mixing arrangement used, the processing assembly would have an upper portion that releasably and sealingly cooperates with the cover 30 as described above, a manifold 46 for receiving a filter assembly, and a suction tube 43 that meters the sample flow of specimen fluid from the bottom of the container.

Filter Assembly

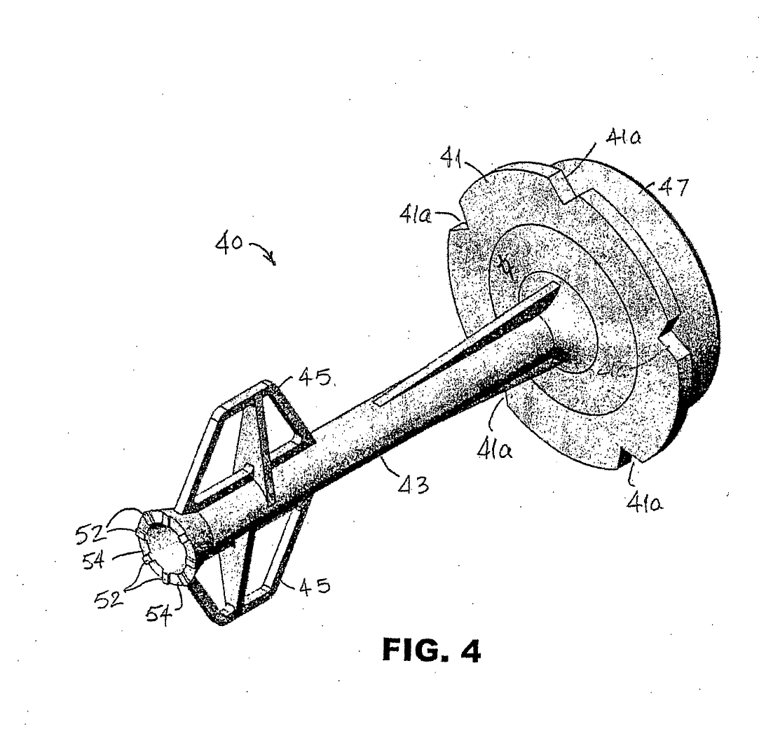

FIG. 10 shows some details of the filter assembly F and its functional cooperation with the stirrer manifold 46 and the inner portion 158 of suction head 152. Filter assembly F comprises a filter holder 200 that accommodates a filter 202. Filter 202 comprises a porous frit 203 and a filter membrane 205 that lies over the lower surface of the frit 203 and is sealed to the periphery of holder 200, e.g., by sonic welding. There is a single, central opening 204 in the top of filter holder 200. The filter 202 (and hence the entire filter assembly F) is supported at its periphery on stirrer base 41 by an array of ribs 48a that define between them radial flow passages 49 (see FIG. 3). The O-rings 154, 155 of inner suction head portion 158 seal against the top of filter holder 200. Suction applied through port 156 creates a vacuum around central opening 204 and within the filter holder 200, which draws liquid into the separation chamber (manifold) 46 and through the filter 202. The flow is vertical through the filter and also across the filter membrane face because of the radial flow passages 49. See FIG. 11, which shows particulate matter (cells) as circles and indicates the flow by arrows. This dual-flow configuration promotes the formation of a monolayer of cells on the filter. See, e.g., the aforementioned U.S. Pat. No. 5,471,994, which describes this dual-flow concept in general. The sloped bottom wall 41 of the manifold 46 further promotes the formation of a monolayer of cells. The constructional details of the filter assembly and its cooperation with the sloped-bottom manifold 46 are set forth in the above-referenced parent application US 2003/0092186 A1. This invention includes an enhancement to the filter assembly, as follows.

Referring to FIGS. 7 and 10, filter holder 200 is provided with a peripheral flange 210 at its upper end, which is configured to contact and effect an annular seal with the annular wall 47 of the separation chamber (manifold) 46. Specifically, flange 210 tapers outwardly at a fixed angle up to a shoulder 212. Because the angle of taper (relative to the central axis of the filter assembly) of flange 210 is not as steep as the angle of taper of the beveled surface 48 of annular wall 47, shoulder 212 is wedged against beveled surface 48 to form a thin annular seal. This annular contact seal prevents any fluid leakage past filter holder 200, and enhances the efficiency and cleanliness of the fluid aspiration operation.

Tamper and Seal Integrity Indicator

A problem sometimes encountered with specimen vials is improper sealing when the cover is reapplied after a specimen has been collected. Clinical personnel do not always tighten screw-on covers completely, which can lead to leakage. The invention provides a seal integrity indicator that will alert anyone handling the vial that the cover may not be properly secured.

Referring to FIGS. 14 and 15, a frangible tape-like strip 70 is adhesively secured to container 20 and the rim 32 of cover 30 when the vial is sealed at the factory. The normal vial label may be applied over the strip 70. In FIGS. 14 and 15 the wider (upper) portion of the strip 70 is seen overlying the rim 32 of the cover, while the narrower portion of the strip is seen overlying the container 20. Of course, strip 70 will break when the vial is opened, such as to insert a specimen. If the strip 70 is broken when received from the factory, it will alert the user to a tampered condition and be discarded. It will also minimize the chance that personnel at the point-of-care site will place two or more specimens into the same vial accidentally.

Strip 70 serves another useful function. The strip has a central index mark 72 that extends over the cover and the container. The edge 74 of the strip represents a boundary mark in relation to the how far the cover can be unscrewed (the “unsealing arc”) before it no longer affords a reliable fluid-tight seal. Specifically, the boundary mark 74 is spaced from the index mark by a distance no greater than the length of the unsealing arc. Thus, as illustrated in FIG. 15 by the dashed line position of the upper portion of the strip, when the index mark 72 on the cover portion is beyond the boundary mark, the user is alerted to a possible unsealed condition, in which case the specimen probably will not be processed.

Automated System

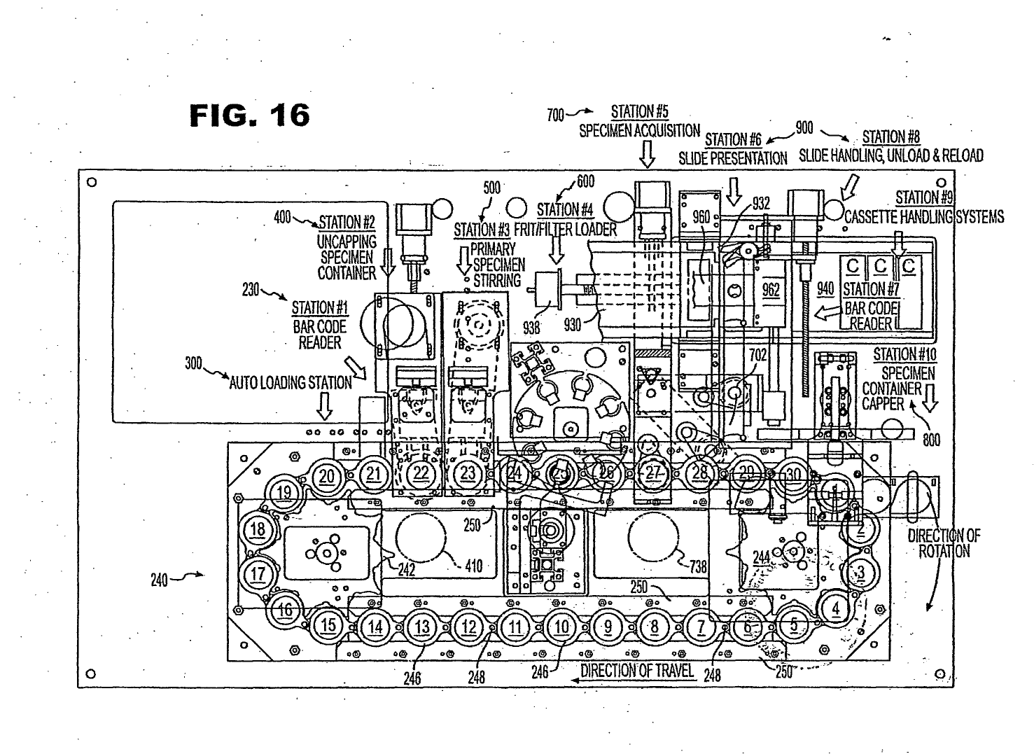

FIG. 16 shows the overall arrangement of one form of automated (computer-controlled) processor for handling specimen vials according to the invention. The device is referred to as an “LBP” device (for liquid-based preparation), and can be integrated into a complete automated laboratory system. Further details of the LBP device and the system are set forth in the above-referenced parent applications.

The LBP processor transports multiple specimen vials sequentially through various processing stations and produces fixed specimens on slides, each slide being bar-coded and linked through a data management system (DMS) to the vial and the patient from which it came. In the preferred arrangement, each vial is transported through the LBP device on a computer-controlled transport (conveyor) 240, in its own receptacle 246. (In the example shown the conveyor has thirty receptacles.) The containers and the receptacles are keyed so that the containers proceed along the processing path in the proper orientation, and cannot rotate independently of their respective receptacles.

The containers first pass a bar code reader 230 (at a data acquisition station), where the vial bar code is read, and then proceed stepwise through the following processing stations of the LBP device: an uncapping station 400 including a cap disposal operation; a preprocessing station 500; a filter loading station 600; a specimen acquisition and filter disposal station 700; and a re-capping station 800. These six stations are structured for parallel processing, meaning that all of these stations can operate simultaneously on different specimens in their respective containers, and independently of the other. The conveyor will not advance until all of these operating stations have completed their respective tasks.

The preprocessing station is the location at which preprocessing operations, such as specimen dispersal within its container, are performed prior to the container and its specimen moving on for further handling. The preprocessing station typically performs a dispersal operation. In the preferred embodiment, the dispersal operation is performed by a mechanical mixer (stirrer 40), which rotates at a fixed speed and for a fixed duration within the specimen container. In this example, the mixer serves to disperse large particulates and microscopic particulates, such as human cells, within the liquid-based specimen by homogenizing the specimen. Alternatively, the specimen may contain subcellular sized objects such as molecules in crystalline or other conformational forms. In that case, a chemical agent may be introduced to the specimen at the preprocessing station to, for example, dissolve certain crystalline structures and allow the molecules to be dispersed throughout the liquid-based specimen through chemical diffusion processes without the need for mechanical agitation. Such a chemical preprocessing station introduces its dispersing agent through the preprocessing head.

There is also an integrated system 900 that includes additional bar code readers, slide cassettes, handling mechanisms for slide cassettes and individual slides, and a slide presentation station 702 at which the specimen acquisition station transfers a representative sample from a specimen to a fresh microscope slide. An optional auto loading mechanism 300 automatically loads and unloads specimen vials onto and from the transport mechanism. All stations and mechanisms are computer-controlled.

In the preferred embodiment of the LBP device disclosed in the parent applications, the vial uncapping station 400 has a rotary gripper that unscrews the cover from the vial, and discards it into a biosafety disposable waste handling bag. Before discarding the cover, however, the uncapping head presses on the center of the cover as described above to detach the internal processing assembly (stirrer) from the cover. The preprocessing (mixing) station 500 has an expanding collet that grips the processing assembly, lifts it slightly and moves (e.g., spins) it in accordance with specimen-specific stirring protocol (speed and duration) instructions associated with a data file on a server linked to the bar code number on the specimen vial. The filter loading station 600 dispenses a specimen-specific filter type into a particulate matter separation chamber (manifold) at the top of the processing assembly. The specimen acquisition station 700 has a suction head that seals to the filter at the top of the processing assembly and first moves the processing assembly slowly to re-suspend particulate matter in the liquid-based specimen. Then the suction head (FIG. 10) draws a vacuum on the filter to aspirate the liquid-based specimen from the vial and past the filter, leaving a thin layer of cells on the bottom surface of the filter. Thereafter the thin layer specimen is transferred to a fresh slide, and the container moves to the re-capping station, where a foil-type seal is applied.

### INDUSTRIAL APPLICABILITY

The invention thus provides an efficient, inexpensive, convenient, safe and effective vial-based system and method for collecting, handling and processing biological specimens and other specimens of particulate matter-containing liquid. It is ideally suited for use in automated equipment that provides consistently reliable processing tailored to sample-specific needs. Such equipment may be part of a complete diagnostic laboratory system.

1. A vial for holding and processing a fluid specimen, comprising:
a container having a surrounding wall defining an opening at its upper end, and a bottom wall closing the bottom end of the surrounding wall; and
a processing assembly disposed in the container comprising a depending tube with an open bottom end, the processing assembly adapted to be engaged through the opening by an external device adapted to remove fluid from the container through the tube, wherein the bottom end of the tube has peripherally spaced feet that contact the bottom wall of the container to define therewith a plurality of peripherally spaced inlets to the tube.

2. A vial according to claim 1, wherein the feet are substantially uniformly spaced around the tube.

3. A vial according to claim 2, wherein the feet have a substantially uniform profile.

4. A vial according to claim 2, wherein the inlets are wider than the feet.

5. A vial according to claim 4, comprising eight feet and eight inlets.

6. A vial according to any one of claims 1 through 5, wherein the minimum dimension of the cross-section of any inlet is in the range of about 0.004 in. to about 0.020 in.

7. A vial according to claim 6, wherein the minimum height of any foot is in the range of about 0.004 in. to about 0.020 in.

8. A vial according to claim 7, wherein the minimum height of any foot is about 0.010 in.

9. A vial according to claim 8, wherein the bottom end of the tube is flared outwardly.

10. A vial according to claim 9, wherein the bottom wall of the container comprises an upstanding central boss that extends into and is spaced from the tube.

11. A vial according to claim 1, wherein the bottom end of the tube is flared outwardly.

12. A vial according to claim 11, wherein the bottom wall of the container comprises an upstanding central boss that extends into and is spaced from the tube.

13. A vial according to claim 1, wherein portions of the surrounding wall below the opening contact and stabilize the processing assembly when the feet contact the bottom wall.

14. A vial according to claim 13, wherein the stabilizing portions of the surrounding wall comprise at least three inwardly extending supports on which an upper portion of the processing assembly rests.

15. A vial according to claim 14, comprising a removable cover adapted to close the opening and engage the processing assembly.

16. A vial according to claim 13, wherein the portion of the bottom wall beneath the feet and surrounding the tube is substantially flat.

17. A vial according to claim 16, wherein the bottom end of the tube is flared outwardly.

18. A vial for holding and processing a fluid specimen, comprising:
a container having a surrounding wall defining an opening at its upper end, and a bottom wall closing the bottom end of the surrounding wall; and
a processing assembly disposed in the container comprising a depending tube with an open bottom end adapted to contact the bottom wall, the processing assembly adapted to be engaged through the opening by an external device adapted to remove fluid from the container through the tube,
wherein the bottom end of the tube and the bottom wall of the container are configured to form a plurality of discrete contact areas at their interface and a plurality of discrete fluid inlets to the tube between the contact areas.

19. A vial according to claim 18, wherein at least one of the bottom end of the tube and the bottom wall of the container has a plurality of standoffs contacting the other.

20. A vial according to claim 19, wherein the standoffs comprise peripherally spaced feet on the bottom end of the tube that contact the bottom wall of the container.

21. A vial according to claim 20, wherein the portion of the bottom wall beneath said at least one foot and surrounding the tube is substantially flat.

22. A vial according to claim 21, wherein the bottom end of the tube is flared outwardly.

23. A vial according to claim 19, wherein the standoffs comprise spaced ribs on the bottom wall of the container that contact the bottom end of the tube.

24. A vial according to claim 23, wherein the ribs are disposed radially.

25. A vial according to claim 24, wherein the ribs radiate from a central boss.

26. A vial according to claim 19, wherein the minimum height of any standoff is in the range of about 0.004 in. to about 0.020 in.

27. A vial according to claim 26, wherein the minimum height of any standoff is about 0.010 in.

28. A vial according to claim 18, wherein the minimum dimension of the cross-section of any inlet is in the range of about 0.004 in. to about 0.020 in.

29. A vial according to claim 18 or claim 19, wherein the bottom wall supports the processing assembly.

30. A vial according to claim 18 or claim 19, wherein the surrounding wall supports the processing assembly.

31. A vial according to claim 30, wherein the surrounding wall supports the processing assembly such that the upper portion of the processing assembly is disposed near the opening.

32. A vial according to claim 31, wherein at least three inwardly extending supports on the surrounding wall support the upper portion of the processing assembly.

33. A vial according to claim 31, wherein the upper portion of the tube has a vent hole in communication with the lumen of the tube above the level of fluid in the vial.

34. A vial for holding and processing a fluid specimen, comprising:
a container having a surrounding wall defining an opening at its upper end, and a bottom wall closing the bottom end of the surrounding wall; and
a processing assembly disposed in the container comprising a depending tube having a plurality of peripheral inlets at or immediately adjacent the bottom end of the tube, the processing assembly adapted to be engaged through the opening by an external device adapted to remove fluid from the container through the tube,
wherein the processing assembly is supported by the container with the bottom end of the tube in contact with or immediately adjacent the bottom wall, whereby fluid can be withdrawn from substantially the lowest portion of the container through the inlets.

35. A vial according to claim 34, wherein the tube has an open bottom end and at least two feet that project below the bottom end of the tube and contact the bottom wall, and the inlets are defined by the feet, the bottom end of the tube and the bottom wall.

36. A vial according to claim 34 or claim 35, wherein the inlets are substantially evenly spaced around the tube.

37. A vial according to claim 36, wherein the inlets are substantially uniform in size and shape.

38. A vial according to claim 37, wherein the portion of the bottom wall beneath and surrounding the bottom end of the tube is substantially flat.

39. A vial according to claim 38, wherein the bottom end of the tube is flared outwardly.

40. A vial according to claim 34 or claim 35, wherein the portion of the bottom wall beneath and surrounding the bottom end of the tube is substantially flat.

41. A vial according to claim 40, wherein the bottom end of the tube is flared outwardly.

42. A vial according to claim 34 or claim 35, wherein the minimum dimension of the cross-section of any inlet is in the range of about 0.004 in. to about 0.020 in.

43. A vial according to claim 40, wherein the minimum dimension of the cross-section of any inlet is about 0.010 in.

44. A vial for holding and processing a fluid specimen, comprising:
a container having a surrounding wall defining an opening at its upper end, and a bottom wall closing the bottom end of the surrounding wall; and
a processing assembly disposed in the container and comprising a depending tube with at least one inlet for fluid at or near the bottom end thereof, the processing assembly adapted to be engaged through the opening by an external device adapted to aspirate fluid from the container through the inlet and through tube,
wherein the upper portion of the tube has a vent hole in communication with the lumen of the tube above the level of fluid in the vial.

45. A vial according to claim 44, wherein the minimum flow area of the vent hole is in the range of about 0.5% to about 15% of the minimum flow area of the lumen of the tube.

46. A vial according to claim 44, wherein the minimum flow area of the vent hole is about 1.6% of the minimum flow area of the lumen of the tube.

47. A method for obtaining a particulate matter sample from a specimen of particulate matter-containing fluid in a container, comprising the steps of:
withdrawing particulate matter-containing fluid from the container through a conduit that communicates with a separation chamber;
introducing a gas into the fluid as it flows from the container, the gas mixing with the fluid to disperse the particulate matter therein; and
separating out particulate matter from the fluid in the separation chamber.

48. A method according to claim 47, wherein the steps of withdrawing fluid from the container and introducing gas into the fluid are effected by applying a vacuum to the separation chamber.

49. A method according to claim 48, wherein the conduit comprises a tube that extends downwardly into the specimen in the container, the tube having a vent hole above the level of fluid in the container, whereby the applied vacuum aspirates fluid upwardly through the tube and aspirates air into the tube through the vent hole.

50. A method according to claim 47, claim 48 or claim 49, wherein the separation chamber houses a filter, and the step of separating out particulate matter from the fluid comprises collecting particulate matter on a surface of the filter.

51. A method according to claim 50, wherein the minimum flow area of the vent hole is in the range of about 0.5% to about 15% of the minimum flow area of the lumen of the tube.

52. A method according to claim 50, wherein the minimum flow area of the vent hole is about 1.6% of the minimum flow area of the lumen of the tube.

53. A method according to claim 50, further comprising the step of transferring the collected particulate matter from the filter to a slide.

54. A method according to claim 50, wherein the specimen of particulate matter-containing fluid is a biological specimen.

55. A method for collecting cells for cytology from a biological specimen fluid in a container, comprising the steps of:
withdrawing specimen fluid from the container through a conduit that communicates with a separation chamber;
introducing a gas into the specimen fluid as it flows from the container, the gas mixing with the specimen fluid to disperse the cells and other biological matter therein; and
separating out cells from the specimen fluid in the separation chamber.

56. A method according to claim 55, wherein the steps of withdrawing specimen fluid from the container and introducing gas into the specimen fluid are effected by applying a vacuum to the separation chamber.

57. A method according to claim 56, wherein the conduit comprises a tube that extends downwardly into the specimen fluid in the container, the tube having a vent hole above the level of specimen fluid in the container, whereby the applied vacuum aspirates specimen fluid upwardly through the tube and aspirates air into the tube through the vent hole.

58. A method according to claim 55, claim 56 or claim 57, wherein the separation chamber houses a filter, and the step of separating out cells from the specimen fluid comprises collecting cells on a surface of the filter.

59. A method according to claim 58, wherein the minimum flow area of the vent hole is in the range of about 0.5% to about 15% of the minimum flow area of the lumen of the tube.

60. A method according to claim 58, wherein the minimum flow area of the vent hole is about 1.6% of the minimum flow area of the lumen of the tube.

61. A method according to claim 58, further comprising the step of transferring the collected cells from the filter to a slide.

62. A vial for holding and processing a fluid specimen, comprising:
a container having a surrounding wall defining an opening at its upper end, a cover-engaging portion near the opening, and a bottom wall closing the bottom end of the surrounding wall;
a removable cover having a container-engaging portion that mates with the cover-engaging portion of the surrounding wall so that the cover can close and seal the opening; and
a processing assembly releasably coupled to the cover so as to be removable from the container with the cover while still coupled to the cover,
wherein the processing assembly has a bottom end that contacts the bottom wall of the container when the cover is fully engaged with the container to close and seal the opening, and the processing assembly is selectively detachable from the cover when the cover is elevated relative to the container so that the processing assembly can remain in the container when the cover is subsequently removed from the container.

63. A vial according to claim 62, wherein at least partial disengagement of the mating engaging portions of the cover and the surrounding wall causes the cover to elevate relative to the container and allow sufficient clearance for the processing assembly to be detached from the cover.

64. A vial according to claim 63, wherein the mating engaging portions of the cover and the surrounding wall comprise screw threads.

65. A vial according to claim 62 or claim 63, wherein the releasable coupling between the cover and the processing assembly comprises mating couplers, respectively carried by the inside of the cover and the upper portion of the processing assembly, that are held together by a retention force and disengage upon application of an external force to the vial that overcomes the retention force.

66. A vial according to claim 65, wherein the container has a central axis extending lengthwise of the container through the opening, and the couplers mate and disengage by relative motion in the axial direction.

67. A vial according to claim 66, wherein the couplers comprise closely fitting annular projections that form a seal when mated.

68. A vial according to claim 67, wherein the upper portion of the processing assembly comprises a base extending transversely of the axis, the annular projection on the processing assembly extending upwardly from the base to define a cup-shaped recess.

69. A vial according to claim 68, wherein the base has a central hole, and the processing assembly further comprises a depending tube attached to the base and in communication with the central hole, the bottom end of the tube contacting the bottom wall of the container when the cover is fully engaged with the container to close and seal the opening.

70. A vial according to claim 69, wherein the cover has a central boss that extends into the cup-shaped recess when the processing assembly is coupled to the cover, the distal end of the central boss contacting or lying close to the base.

71. A vial according to claim 70, wherein a stopper is retained in the central boss and seals the central hole in the base when the processing assembly is coupled to the cover.

72. A vial according to claim 71, wherein the external force is applied to the central portion of the cover so as to deflect the cover inwardly to press the central boss and/or the stopper against the base and push the base and the annular projection thereon away from the cover.

73. A vial according to claim 72, wherein the annular projection on the base fits within the annular projection on the cover, and the external force deflects the annular projection on the cover outwardly, away from the annular projection on the base.

74. A vial according to claim 70, wherein the annular projection on the base is spaced inwardly from the periphery of the base, and the portion of the base outside of the annular projection comprises at least one drainage aperture that allows fluid to drain from above the base into the container.

75. A vial according to claim 74, wherein the at least one drainage aperture comprises a peripheral notch.

76. A vial according to claim 75, wherein the at least one drainage aperture comprises a plurality of spaced peripheral notches.

77. A method for processing a fluid specimen in a vial, the vial comprising a container having a surrounding wall defining an opening at its upper end and a bottom wall closing the bottom end of the surrounding wall, a cover removably engageable with the surrounding wall to close the opening, and a processing assembly releasably coupled to the inside of the cover, the method comprising the steps of:
at least partially disengaging the cover from the container to elevate the cover and the attached processing assembly;
detaching the processing assembly from the cover to deposit the processing assembly in the container;
completely removing the cover from the container to expose the detached processing assembly in the container; and
manipulating the processing assembly so as to process the specimen in the container.

78. A method according to claim 77, wherein the detaching step comprises applying an external force to the central portion of the cover to deflect the cover inwardly.

79. A method according to claim 77 or claim 78, wherein the processing assembly comprises a dispersing element, and the manipulating step comprises moving at least the dispersing element to mix the fluid specimen.

80. A method according to claim 79, wherein the step of moving the dispersing element comprises rotating the processing assembly to cause the dispersing element to mix the fluid specimen.

81. A method according to claim 79, wherein the step of moving the dispersing element comprises first lifting the processing assembly slightly to insure clearance between the processing assembly and the container, and then rotating the processing assembly to cause the dispersing element to mix the fluid specimen.

82. A method according to claim 80, wherein the processing assembly comprises a particulate matter separation chamber at the upper portion thereof adapted to hold a filter assembly, and a tube communicating with the separation chamber and extending downwardly therefrom, and the manipulating step further comprises placing a filter assembly in the separation chamber, sealing the separation chamber, and applying a vacuum to the separation chamber to draw the mixed fluid specimen upwardly through the tube and into contact with the filter assembly so as to collect particulate matter from the specimen on a surface of the filter assembly.

83. A method according to claim 82, further comprising removing the filter assembly from the separation chamber and contacting the particulate matter collected on the filter assembly with a slide so as to transfer collected particulate matter to the slide.

84. A method according to claim 77, wherein the cover and the surrounding wall of the container have mating screw threads, and the step of at least partially disengaging the cover from the container comprises at least partially unscrewing the cover from the container.

85. A method for processing a fluid specimen in a vial, the vial comprising a container having a surrounding wall defining an opening at its upper end and a bottom wall closing the bottom end of the surrounding wall, a cover removably engageable with the surrounding wall to close the opening, and a processing assembly releasably coupled to the inside of the cover and wedged between the cover and the bottom wall of the container when the cover is fully engaged with the surrounding wall, the method comprising the steps of:
at least partially disengaging the cover from the container to elevate the cover and the attached processing assembly to provide sufficient clearance between the processing assembly and the bottom wall to allow the processing assembly to be detached from the cover;
detaching the processing assembly from the cover to deposit the processing assembly in the container;
completely removing the cover from the container to expose the detached processing assembly in the container; and
manipulating the processing assembly so as to process the specimen in the container.

86. A method according to claim 85, wherein the detaching step comprises applying an external force to the central portion of the cover to deflect the cover inwardly.

87. A method according to claim 85 or claim 86, wherein the processing assembly comprises a dispersing element, and the manipulating step comprises moving at least the dispersing element to mix the fluid specimen.

88. A method according to claim 87, wherein the step of moving the dispersing element comprises rotating the processing assembly to cause the dispersing element to mix the fluid specimen.

89. A method according to claim 87, wherein the step of moving the dispersing element comprises first lifting the processing assembly slightly to insure clearance between the processing assembly and the container, and then rotating the processing assembly to cause the dispersing element to mix the fluid specimen.

90. A method according to claim 88, wherein the processing assembly comprises a particulate matter separation chamber at the upper portion thereof adapted to hold a filter assembly, and a tube communicating with the separation chamber and extending downwardly therefrom, and the manipulating step further comprises placing a filter assembly in the separation chamber, sealing the separation chamber, and applying a vacuum to the separation chamber to draw the mixed fluid specimen upwardly through the tube and into contact with the filter assembly so as to collect particulate matter from the specimen on a surface of the filter assembly.

91. A method according to claim 90, further comprising removing the filter assembly from the separation chamber and contacting the particulate matter collected on the filter assembly with a slide so as to transfer collected particulate matter to the slide.

92. A method according to claim 85, wherein the cover and the surrounding wall of the container have mating screw threads, and the step of at least partially disengaging the cover from the container comprises at least partially unscrewing the cover from the container.

93. A vial for holding and processing a fluid specimen, comprising:
a container having a surrounding wall defining an opening at its upper end, a cover-engaging portion near the opening, and a bottom wall closing the bottom end of the surrounding wall;
a removable cover having a container-engaging portion that mates with the cover-engaging portion of the surrounding wall so that the cover closes and seals the opening; and
a processing assembly in the container comprising an upper portion disposed near the opening, the upper portion comprising a base with a hole, and an annular projection surrounding the hole and extending upwardly from the base to define a cup-shaped recess,
wherein the cover has an annular sealing member that mates and seals with the annular projection on the processing assembly when the cover closes and seals the opening, and a depending hole sealing member that seals the hole in the base when the cover closes and seals the opening.

94. A vial according to claim 93, wherein the processing assembly further comprises a depending tube attached to the base and in communication with the hole.

95. A vial according to claim 93 or claim 94, wherein the hole is located centrally of the base.

96. A vial according to claim 95, wherein the hole sealing member comprises a stopper, and the cover has a depending central boss that retains the stopper.

97. A vial according to claim 96, wherein the annular projection on the base is spaced inwardly from the periphery of the base, and the portion of the base outside of the annular projection comprises at least one drainage aperture that allows fluid to drain from above the base into the container.

98. A vial according to claim 97, wherein the at least one drainage aperture comprises a peripheral notch.

99. A vial according to claim 98, wherein the at least one drainage aperture comprises a plurality of spaced peripheral notches.

100. A vial according to claim 99, wherein the bottom end of the tube contacts the bottom wall of the container when the cover is fully engaged with the container to close and seal the opening.

101. A vial according to claim 94, wherein the bottom end of the tube contacts the bottom wall of the container when the cover is fully engaged with the container to close and seal the opening.

102. A vial for holding and processing a fluid specimen, comprising:
a container having a surrounding wall defining an opening at its upper end, a cover-engaging portion near the opening, and a bottom wall closing the bottom end of the surrounding wall;
a removable cover having a container-engaging portion that mates with the cover-engaging portion of the surrounding wall so that the cover closes and seals the opening; and
a processing assembly releasably coupled to the cover so as to be removable from the container with the cover while still coupled to the cover, or detached from the cover to remain in the container,
wherein the processing assembly comprises a base with a hole, a depending tube attached to the base and in communication with the hole, and an annular projection surrounding the hole and extending upwardly from the base to define a cup-shaped recess,
wherein the cover has a depending annular sealing member that mates and seals with the annular projection on the processing assembly when the processing assembly is coupled to the cover, and a depending hole sealing member that seals the hole in the base when the processing assembly is coupled to the cover.

103. A vial according to claim 102, wherein the bottom end of the tube contacts the bottom wall of the container when the cover is fully engaged with the container to close and seal the opening.

104. A vial according to claim 102 or claim 103, wherein the annular sealing member on the cover comprises an annular projection that seals against the inside of the surrounding wall of the container, and the annular projection on the base fits within the annular projection on the cover.

105. A vial according to claim 104, wherein the hole sealing member comprises a stopper, and the cover has a depending boss that retains the stopper.

106. A vial according to claim 105, wherein the hole and the tube are located centrally of the base.

107. A vial according to claim 104, wherein the annular projection on the base is spaced inwardly from the periphery of the base, and the portion of the base outside of the annular projection comprises at least one drainage aperture that allows fluid to drain from above the base into the container.

108. A vial according to claim 107, wherein the at least one drainage aperture comprises a peripheral notch.

109. A vial according to claim 108, wherein the at least one drainage aperture comprises a plurality of spaced peripheral notches.

110. A vial according to claim 109, wherein the hole and the tube are located centrally of the base.

111. A vial according to claim 102, wherein the hole and the tube are located centrally of the base.

112. A filter assembly adapted for use in apparatus for separating and collecting a layer of particulate matter from a fluid containing the particulate matter, the apparatus having a particulate matter separation chamber into which the filter is placed, the separation chamber defined by a bottom wall with a fluid inlet and an annular wall projecting upwardly from the bottom wall, wherein the filter assembly comprises a holder and a filter in the holder having a collection site adapted to collect a layer of the particulate matter, and the holder is configured to contact and effect an annular seal with the annular wall of the separation chamber when the filter assembly is positioned in the separation chamber with the filter facing the bottom wall.

113. A filter assembly according to claim 112, wherein the upper margin of the holder is flared outwardly to define a flange that seals against the annular wall of the separation chamber.

114. A filter assembly according to claim 113, wherein the upper margin of the inner face of the annular wall of the separation chamber tapers inwardly, and the periphery of the flange is adapted to seal against the tapered surface of the annular wall of the separation chamber.

115. A filter assembly according to claim 114, wherein the periphery of the flange forms a thin annular seal against the tapered surface of the annular wall of the separation chamber.

116. A filter assembly according to claim 115, wherein the holder and the filter are substantially symmetrical about a central axis of the filter assembly.

117. A filter assembly according to claim 113, wherein the holder and the filter are substantially symmetrical about a central axis of the filter assembly, the upper margin of the holder is flared outwardly at a fixed angle α to the central axis, the upper margin of the inner face of the annular wall of the separation chamber tapers inwardly at a fixed angle β to the central axis, and the angle β is smaller than the angle α, whereby the periphery of the flange is adapted to seal against the tapered surface of the annular wall of the separation chamber.

118. A filter assembly according to claim 117, wherein the periphery of the flange forms a thin annular seal against the tapered surface of the annular wall of the separation chamber.

119. A specimen vial comprising a container, a removable cover for the container and a frangible indicator element secured to the container and the periphery of the cover,
wherein the cover and the upper portion of the container have mating coupling elements that engage or disengage by relative rotation of the container and the cover, and mating sealing portions for effecting and maintaining an air-tight seal between the cover and the container from a fully engaged cover position through an unsealing arc that extends up to a partially engaged cover position at which the sealing portions no longer maintain a reliable seal, and
wherein the indicator element is secured to the container and the periphery of the cover when the cover is in the fully engaged position, the indicator element has an index mark on at least the cover portion thereof, and the container portion of the indicator element has a boundary mark spaced from the index mark when the indicator element is unbroken by a distance no greater than the length of the unsealing arc,
whereby removal or loosening of the cover will break the indicator element, and a partially disengaged cover condition with the cover-borne index mark beyond the boundary mark will indicate an unreliably sealed condition of the vial.

120. A specimen vial according to claim 119, wherein the boundary mark comprises an edge of the indicator element.

121. A specimen vial according to claim 119 or claim 120, wherein the index mark is on the cover and the container portions of the indicator element.

122. A specimen vial according to claim 119, wherein the mating coupling elements comprise screw threads.

123. A specimen vial according to claim 119 or claim 120, wherein the mating sealing portions comprise the inside surface of the upper portion of the container and a cylindrical plug on the underside of the cap that seals against the inside surface of the container.

124. A specimen vial according to claim 119, further comprising a label applied to the container over a portion of the indicator element.
